(19) United States
(12) Patent Application Publication
(10) Pub. No.: US 2025/0046838 A1
(43) Pub. Date: Feb. 6, 2025

(54) METHOD FOR DIAGNOSING THE OPERATING STATUS OF A FUEL CELL SYSTEM, METHOD FOR CONTROLLING A FUEL CELL SYSTEM, AND A FUEL CELL SYSTEM

(71) Applicant: FEV Group GmbH, Aachen (DE)

(72) Inventors: Marius ZUBEL, Aachen (DE); Marius WALTERS, Aachen (DE); Joschka SCHAUB, Aachen (DE); Vivek SRIVASTAVA, Aachen (DE)

(73) Assignee: FEV Group GmbH, Aachen (DE)

(21) Appl. No.: 18/788,617

(22) Filed: Jul. 30, 2024

(30) Foreign Application Priority Data
Jul. 31, 2023 (DE) 102023120280.4

(51) Int. Cl. H01M 8/04537; H01M 8/0432; H01M 8/0438; H01M 8/04492

(52) U.S. Cl. CPC H01M 8/04611; H01M 8/0432; H01M 8/0438; H01M 8/04492; H01M 8/04582

(57) ABSTRACT

A method for diagnosing an operating status of a fuel cell system having a fuel cell and a system for operating media management, includes creating an operating model (M) of the fuel cell, including an electrochemical model (ecM) and a physical model (pM) coupled thereto. By the electrochemical model (ecM), an electrical operating power (P) of the fuel cell is determinable as a function of an electrical operating current (J) and thermodynamic operating parameters (Σ). By the physical model (pM), a time-dependent spatial distribution of the thermodynamic operating parameters (Σ) is determinable. The method further includes: detecting the electrical operating current (J) of the fuel cell and status variables (Ψ) of operating media of the fuel cell; and determining the electrical operating power of the fuel cell by the operating model (M) based on the detected electrical operating current (J) and the detected status variables (Ψ) of the operating media.

### CROSS-REFERENCE TO RELATED APPLICATION

This application claims priority to and the benefit of DE 102023120280.4, filed on Jul. 31 2023, the disclosure of which is incorporated herein by reference in its entirety.

### FIELD

The present disclosure relates to a method for diagnosing the operating status of a fuel cell system, a method based thereon for controlling a fuel cell system, and a fuel cell system having at least one fuel cell, a system for operating media management, and a control unit, which is designed to carry out the method according to the invention.

### BACKGROUND

The statements in this section merely provide background information related to the present disclosure and may not constitute prior art.

Fuel cell systems for driving vehicles are typically based on proton exchange membrane fuel cells (PEM fuel cells) for hydrogen as a fuel. Such a fuel cell system comprises a PEM fuel cell stack and a system connected thereto for operating media management, in particular for anode hydrogen supply, cathode air supply, and cooling.

The electrochemical and physical processes running in operation of PEM fuel cells are very complex and the functional components, in particular the proton exchange membrane, are subjected to manifold degradation and wear processes. The most accurate possible knowledge of the respective operating status is sought for the control of the fuel cell system, for which purpose in the prior art, for example, impedance spectroscopy is carried out for the real-time diagnosis of the electrochemical processes in the fuel cells.

### SUMMARY

This section provides a general summary of the disclosure and is not a comprehensive disclosure of its full scope or all of its features.

In one form, a method for diagnosing the operating status of a fuel cell system having at least one fuel cell and a system for operating media management is provided. An operating model of the fuel cell is created, which includes an electrochemical model and a physical model coupled thereto. By means of the electrochemical model, an electrical operating power of the fuel cell is determinable as a function of an electrical operating current and of thermodynamic operating parameters. By means of the physical model, a time-dependent spatial distribution of the thermodynamic operating parameters is determinable. At least the following steps are continuously carried out for the diagnosis of the operating status: detecting the electrical operating current of the fuel cell and status variables of operating media of the fuel cell, wherein the status variables of the operating media are detected on the input side and/or output side of the fuel cell; and determining the electrical operating power of the fuel cell by means of the operating model based on the detected electrical operating current and the detected status variables of the operating media.

The concept of the invention is to use a comprehensive operating model for the running prediction of the electrical operating power of the fuel cell, wherein the operating model models both electrochemical processes within the fuel cell, expediently with spatial and temporal resolution, for example the ion diffusion through the membrane and the kinetics of the electrochemical partial reactions, and also models the relevant thermodynamic operating parameters by means of a physical model. The latter includes in particular the temperature of the cell membrane, the temperatures of the operating media, the pressures of the operating media, the volume flows of the operating media, the material amount concentration of the operating media, and/or the humidity of the operating media. The electrochemical model and the physical model are coupled with one another in this case. The values of the thermodynamic operating parameters determined by the physical model form input variables of the electrochemical model. For example, the values of the concentration losses of the reactants determined by means of the electrochemical model and/or the local waste heat ascertained from the efficiency of the cell reaction are in turn transferred to the physical model. The electrical operating power of the fuel cell modeled based on the actual flowing electric current is output as a measure of its operating status. The operating power thus ascertained can be used in particular to control the fuel cell system. Moreover, for example, a statement about the present degree of degradation can be obtained therefrom via a comparison to an ideal polarization curve, in particular a polarization curve ascertained experimentally on a fuel cell system which is as good as new, i.e. is unworn.

In operation of the fuel cell system, the modeling to predict the electrical operating power is in particular carried out continuously, for which purpose a continuous detection of the electric current requested by a connected electrical consumer, in particular an electrical vehicle motor, is carried out as an input variable for the operating model. Status variables of operating media of the fuel cell are continuously detected as further input variables, wherein a fuel, in particular hydrogen, an oxidant, in particular aspirated fresh air, an anode exhaust gas, a cathode exhaust gas, and/or a cooling fluid are taken into consideration as operating media of the fuel cell, for example. The detected status variables comprise in particular the temperatures, pressures, volume flows, and/or moisture contents of the operating media, wherein sensors arranged upstream and/or downstream of the fuel cell can be used for the detection.

In an advantageous embodiment of the method according to the present disclosure, the electrochemical model is based on an electrical equivalent circuit diagram, and/or the physical model is based on a thermal equivalent circuit diagram and/or a hydraulic equivalent circuit diagram. In particular, all models are based on expedient equivalent circuit diagrams. The electrical equivalent circuit diagram is a representation of the electrochemical functionality of the fuel cell by means of decomposition into electrical equivalent individual parts, wherein the equivalent circuit diagram simulates the behavior of the fuel cell as exactly as possible. In particular linear and nonlinear resistors and capacitors are available as passive electric dipoles for modeling. Analogously to electrical equivalent circuit diagrams, thermal and hydraulic equivalent circuit diagrams can be prepared for the modeling of the heat transfer and the flow-mechanical phenomena during the transport of the operating media. The node and network rules known from electrical network analysis can advantageously be used here for the calculation. For example, a temperature or pressure difference corresponds to the electrical potential difference, a heat or volume flow corresponds to the electric current, and a thermal resistance or a flow resistance corresponds to the electric resistance, wherein the thermal resistance is composed in particular of components of heat conduction and convection.

In particular, the operating model has a discretization into segments interconnected with one another, wherein each segment comprises an electrochemical partial model and a physical partial model coupled thereto. Each segment represents a spatial section of the modeled fuel cell, and a segmentation optimized for the respective application and the available computing capacity can be performed.

In an operating model for a fuel cell system having a fuel cell stack which comprises a plurality of fuel cells electrically interconnected in series, the equivalent circuit diagrams of the electrochemical model and the physical model have a corresponding plurality of circuit levels interconnected with one another.

The invention further relates to a method for controlling a fuel cell system having at least one fuel cell and a system for operating media management, wherein the method for diagnosing the operating status of the fuel cell system according to one of the above-mentioned embodiments is carried out, and wherein the management of the operating media is controlled in dependence on the diagnosed operating status of the fuel cell system.

In addition, the invention relates to a fuel cell system having at least one fuel cell, a system for operating media management, and having a control unit, which is designed to carry out the diagnosis method according to the invention and/or the control method according to the invention. The control unit is at least indirectly connected for communication to all components of the fuel cell system necessary to carry out the method, and moreover in particular has a storage and computing unit for storing the operating model and continuously determining the electrical operating power of the fuel cell by means of the operating model based on the detected electrical operating current and the detected status variables of the operating media.

Furthermore, the invention relates to a computer program product having program code which is stored on a computer-readable medium for carrying out the method according to the invention according to one of the above-mentioned embodiments. The computer program product can be stored in particular on the control unit of the fuel cell system according to the invention and can be executed thereby.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a schematic representation of an electrochemical model and a physical model; and

FIG. 2 shows a schematic representation of an operating model according to the invention.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

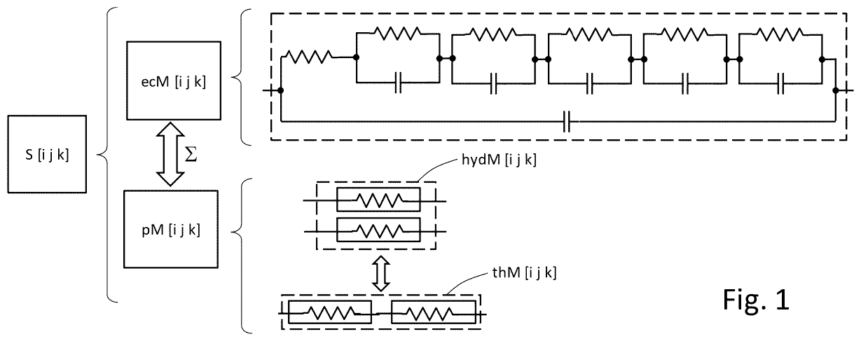

FIG. 1 shows a schematic representation of a segment S as part of an operating model according to the invention, wherein the segment S comprises the electrochemical partial model ecM and the physical partial model pM coupled thereto. The index tuple [ijk] designates the position of the segment S in the three-dimensional discretized operating model. The electrochemical partial model ecM is based on an electrical equivalent circuit diagram, which models activation losses and concentration losses here, for example. Activation losses result from voltage losses during the kinetically inhibited charge passage from the electron-conducting to the ion-conducting phase, i.e. when overcoming the electrochemical double layers at the interfaces between the cell membrane and anode or cathode. The activation losses limit the electrical operating power of the fuel cell at low current densities. The associated equivalent circuit diagram comprises in the present case a double-layer capacitance in a parallel circuit with an ohmic resistance. In the diffusion-controlled range of the polarization curve, i.e. at high current densities, concentration losses occur due to the high reaction rates of the reactants, which results in a significant drop of the electrical operating power. The concentration losses are modeled in the present case by a series of Warburg impedances. The specific values of the electric dipoles in the illustrated equivalent circuit diagram of the electrochemical partial model ecM are dependent on the thermodynamic operating parameters E. The latter are provided by the physical partial model pM coupled to the electrochemical partial model ecM.

The physical partial model is based in the present exemplary embodiment on a thermal equivalent circuit diagram thM and a hydraulic equivalent circuit diagram hydM. The thermal equivalent circuit diagram thM comprises two serial resistances, which represent the contributions of heat conduction and convection to the heat transport resistance of the segment S. The hydraulic equivalent circuit diagram hydM takes into consideration the flow resistances for the anode-side fuel and the cathode-side oxidant. The flow resistances are given, for example, by the geometry of the media channels of the bipolar plates and the structure of the diffusion layers on the electrodes.

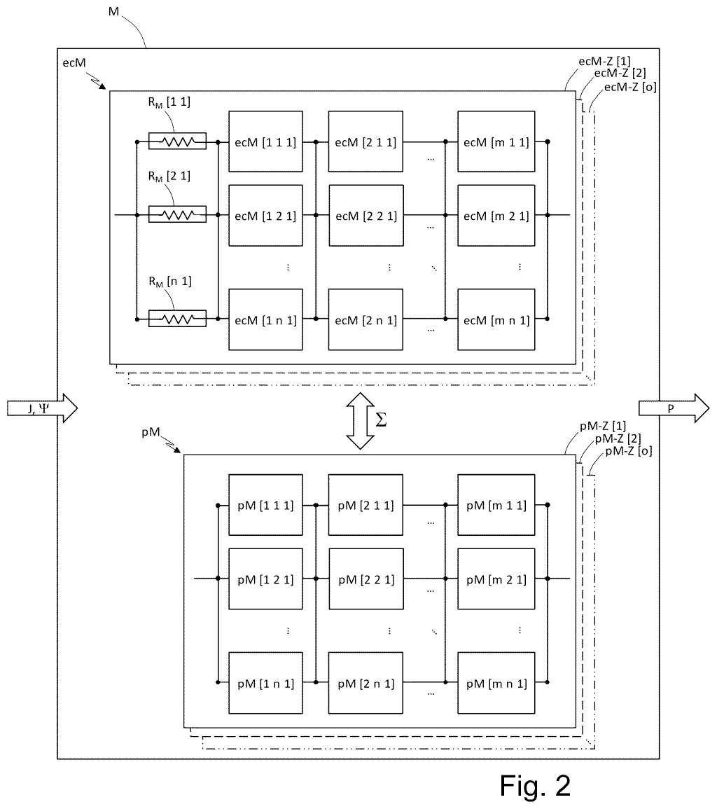

FIG. 2 shows a schematic representation of an operating model M for the method according to the invention for diagnosing the operating status of a fuel cell system, comprising the electrochemical model ecM and the physical model pM coupled thereto. By means of the electrochemical model ecM, an electrical operating power P of the fuel cell is determinable as a function of an electrical operating current J and of thermodynamic operating parameters Σ, and by means of the physical model pM, a time-dependent spatial distribution of the thermodynamic operating parameters Σ is determinable. In the course of the method according to the invention, in operation of the fuel cell system to be monitored, the electrical operating current J and the status variables Ψ of operating media of the fuel cell are continuously detected and transferred as input variables to the operating model M.

The operating model M models a fuel cell system having a fuel cell stack having a plurality of fuel cells, wherein the equivalent circuit diagrams of the electrochemical model ecM and the physical model pM have a corresponding plurality of circuit levels ecM-Z, pM-Z interconnected with one another.

A segmentation is present within each circuit level ecM-Z, pM-Z, which corresponds to a spatial discretization of the respective modeled fuel cell. The columns of the equivalent circuit diagrams correspond to the course of the cathode-side operating media channels for the supplied oxidant in this case, typically humidified fresh air, which is also responsible for the humidification of the cell membrane. Therefore, a uniform membrane resistance R_{M} is used for simplification for each row of the equivalent circuit diagram in the electrochemical model ecM, since this is significantly determined by the moisture content of the cell membrane and is assumed to be homogeneous perpendicular to the cathode-side operating media channels. A physical partial model pM[ijk] is coupled segment by segment to each electrochemical partial model ecM[ijk], so that the electrochemical and the physical processes are modeled with the same spatial resolution.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for diagnosing an operating status of a fuel cell system having at least one fuel cell and a system for operating media management, the method comprising:
creating an operating model (M) of the fuel cell, which comprises an electrochemical model (ecM) and a physical model (pM) coupled thereto, wherein:
by means of the electrochemical model (ecM), an electrical operating power (P) of the fuel cell is determinable as a function of an electrical operating current (J) and of thermodynamic operating parameters (Σ), and
by means of the physical model (pM), a time-dependent spatial distribution of the thermodynamic operating parameters (Σ) is determinable;
the method further comprising continuously carrying out:
detecting the electrical operating current (J) of the fuel cell and status variables (Ψ) of operating media of the fuel cell, wherein the status variables (Ψ) of the operating media are detected on an input side and/or an output side of the fuel cell, and
determining the electrical operating power of the fuel cell by means of the operating model (M) based on the detected electrical operating current (J) and the detected status variables (Ψ) of the operating media.

2. The method as claimed in claim 1, wherein the thermodynamic operating parameters (Σ) determined by means of the physical model (pM) in time-dependent spatial distribution comprise a temperature of a proton exchange membrane of the fuel cell, a temperatures of the operating media, a pressures of the operating media, volume flows of the operating media, a material amount concentration of the operating media, and/or a humidity of the operating media.

3. The method as claimed in claim 1, wherein a fuel, in particular hydrogen, an oxidant, in particular aspirated fresh air, an anode exhaust gas, a cathode exhaust gas, and/or a cooling fluid are taken into consideration as operating media of the fuel cell.

4. The method as claimed in claim 1, wherein the electrochemical model (ecM) is based on an electrical equivalent circuit diagram, and/or the physical model (pM) is based on a thermal equivalent circuit diagram (thM) and/or a hydraulic equivalent circuit diagram (hydM).

5. The method as claimed in claim 4, wherein the operating model has a discretization into segments (S) interconnected with one another, wherein each segment (S) comprises an electrochemical partial model and a physical partial model coupled thereto.

6. The method as claimed in claim 4, wherein the fuel cell system comprises a fuel cell stack having a plurality of fuel cells, and wherein the equivalent circuit diagrams of the electrochemical model (ecM) and the physical model (pM) have a corresponding plurality of circuit levels (ecM-Z, pM-Z) interconnected with one another.

7. A method for controlling a fuel cell system having at least one fuel cell and a system for operating media management, wherein management of the operating media is controlled based on the diagnosed operating status of the fuel cell system as claimed in claim 1.

8. A fuel cell system having at least one fuel cell, a system for operating media management, and having a control unit, which is configured to carry out the method as claimed in claim 1.

9. A computer program product having program code which is stored on a computer-readable medium for carrying out the method as claimed in claim 1.
